(19) United States
(12) Patent Application Publication
(10) Pub. No.: US 2013/0342168 A1
(43) Pub. Date: Dec. 26, 2013

(54) ELECTRICAL STORAGE DEVICE

(71) Applicants: Motoyoshi Okumura, Chiryu-shi (JP); Yoshifumi Ota, Okazaki-shi (JP); Masahiko Kubo, Nissin-shi (JP); Yukiko Ibe, Toyota-shi (JP)

(72) Inventors: Motoyoshi Okumura, Chiryu-shi (JP); Yoshifumi Ota, Okazaki-shi (JP); Masahiko Kubo, Nissin-shi (JP); Yukiko Ibe, Toyota-shi (JP)

(73) Assignee: TOYOTA JIDOSHA KABUSHIKI KAISHA, Toyota-shi, Aichi (JP)

(21) Appl. No.: 14/003,368

(22) PCT Filed: Mar. 16, 2011
(86) PCT No.: PCT/JP2011/001548

§ 371 Date: Sep. 5, 2013

(51) Int. Cl. H02J 7/00

(52) U.S. Cl. CPC H02J 7/0029; H02J 7/0068
USPC 320/118; 320/167

(57) ABSTRACT

An electrical storage device includes a plurality of power-generating elements, a case, and a valve. The power-generating elements perform charge and discharge and are connected electrically in series. A plurality of housing sections each accommodate one of the plurality of power-generating elements and are disposed along a predetermined direction. A communication path switches from a closed state to an opened state depending on the internal pressure of the housing section. When the communication path is in the opened state, gas can be moved between two of the housing sections adjacent to each other in the predetermined direction. The valve is provided for a particular housing section and releases gas produced within the case to the outside of the case. The empty space other than the power-generating element is present in each of the housing sections, and the empty space in the particular housing section is the largest.

### TECHNICAL FIELD

The present invention relates to an electrical storage device having a plurality of power-generating elements each housed in one of a plurality of housing sections separated within a case.

### BACKGROUND ART

Patent Document 1 has described a battery in which a plurality of housing sections disposed along one direction are formed within a case and each of power-generating elements is housed in each of the housing sections. The plurality of power-generating elements are connected electrically in series to each other. The case is provided with a positive electrode terminal connected electrically to one of the power-generating elements and a negative electrode terminal connected electrically to another one of the power-generating elements.

The plurality of housing sections are connected to each other through a communication path. When gas is produced from the power-generating element housed in a particular one of the housing sections, the gas moves through the communication path to the other housing sections. A valve is provided for the case (a particular one of the housing sections) and releases the gas guided to that particular housing section to the outside of the case.

### PRIOR ART DOCUMENTS

### Patent Documents

[Patent Document 1] Japanese Patent Laid-Open No. 2003-346763

[Patent Document 2] Japanese Patent Laid-Open No. 2008-311015

[Patent Document 3] Japanese Patent Laid-Open No. 2004-319096

### DISCLOSURE OF THE INVENTION

### Problems to be Solved by the Invention

When no gas is produced from the power-generating element, the communication path can be set in a closed state. In other words, the plurality of housing sections can be formed of the respective independent spaces. Once gas is produced from the power-generating element, the communication path can be switched from the closed state to an opened state to move the gas to the other housing sections.

In the configuration in which the two adjacent housing sections are connected to each other through the communication path, the internal pressure of one (referred as a first housing section) of the housing sections closer to the housing section provided with the valve maybe higher than the internal pressure of the other housing section (referred to as a second housing section) farther from the housing section provided with the valve. In this case, gas produced in the second housing section is prevented from smoothly passing through the first housing section to the housing section provided with the valve. In the second housing section, the produced gas may continuously increase the internal pressure to apply an excessive load to the case.

### Means for Solving the Problems

According to a first aspect, the present invention provides an electrical storage device including a plurality of power-generating elements, a case, and a valve. The power-generating elements perform charge and discharge and are connected electrically in series to each other. A plurality of housing sections each accommodate one of the plurality of power-generating elements and are disposed along a predetermined direction. A communication path switches from a closed state to an opened state depending on the internal pressure of the housing section. While the communication path is in the opened state, gas can be moved between two of the housing sections adjacent to each other in the predetermined direction. The valve is provided for a particular one of the housing sections and releases gas produced within the case to the outside of the case. An empty space other than the power-generating element is present in each of the housing sections, and the empty space in the particular one of the housing sections is the largest.

According to the first aspect of the present invention, the empty space can be varied among the housing sections to vary the internal pressure among the housing sections at the time of the gas production from the power-generating element. Since the empty space is the largest in the particular housing section, the internal pressure of the particular housing section can be the lowest to direct the gas produced from the other housing sections toward the particular housing section. Once the gas is moved to the particular housing section, the gas can be released through the valve provided for the particular housing section.

The housing sections other than the particular housing section can have the empty spaces reduced gradually with the distance from the particular housing section in the predetermined direction. When the gas is produced in each of the housing sections, the internal pressure of each of the housing sections can be increased with the distance from the particular housing section. Thus, the gas can be moved smoothly from the housing section farthest from the particular housing section toward the particular housing section. Once the gas is guided to the particular housing section, the gas can be released through the valve provided for the particular housing section.

When the plurality of power-generating elements have the same volume, the particular housing section can have a volumetric capacity larger than the volumetric capacities of the other housing sections. The volumetric capacity can be varied among the housing sections to vary the empty space among the housing sections such that the relationship described above is achieved. The other housing sections can have the volumetric capacities reduced gradually with the distance from the particular housing section in the predetermined direction.

When the plurality of housing sections have the same volumetric capacity and the plurality of power-generating elements have the same electrical capacity, the power-generating element housed in the particular housing section can have a volume smaller than the volumes of the power-generating elements housed in the other housing sections. The volume can be varied among the power-generating elements to vary the empty space among the housing sections such that the relationship described above is achieved. In performing charge and discharge of the electrical storage device, variations in electrical capacity among the plurality of power-generating elements are preferably suppressed.

The power-generating element includes a reaction area where charge and discharge occur and a non-reaction area other than the reaction area. The volume can be varied among the non-reaction areas to vary the volume among the plurality of power-generating elements without varying the electrical capacity among the plurality of power-generating elements. Specifically, the non-reaction area of the power-generating element housed in the particular housing section can be smaller than the non-reaction area of the power-generating elements housed in the other housing sections. The non-reaction areas of the power-generating elements housed in the other housing sections can have the volumes increased gradually with the distance from the particular housing section in the predetermined direction.

Each of the housing sections can be filled with an electrolytic solution. When the plurality of housing sections have the same volumetric capacity and the plurality of power-generating elements have the same volume, the amount of the electrolytic solution filled into the particular housing section can be smaller than the amounts of the electrolytic solution filled into the other housing sections. The amount of electrolytic solution can be varied to vary the empty space among the housing sections such that the relationship described above is achieved. The amounts of electrolytic solution filled into the other housing sections can be increased with the distance from the particular housing section in the predetermined direction.

According to a second aspect, the present invention provides an electrical storage device including a plurality of power-generating elements, a case, and a valve. The power-generating elements perform charge and discharge and are connected electrically in series to each other. The case has a plurality of housing sections and a communication path. The plurality of housing sections each accommodate one of the plurality of power-generating elements and are disposed along a predetermined direction. The communication path switches from a closed state to an opened state depending on the internal pressure of the housing section. When the communication path is in the opened state, gas can be moved between two of the housing sections adjacent to each other in the predetermined direction. The valve is provided for a particular one of the housing sections and releases gas produced within the case to the outside of the case. The electrical capacity of the power-generating element housed in the particular one of the housing sections is the largest.

According to the second aspect of the present invention, the electrical capacity can be varied among the power-generating elements to vary the amount of gas produced from the power-generating element. Specifically, as the electrical capacity of the power-generating element is increased, the amount of gas can be reduced. The amount of gas can be varied to vary the internal pressure among the housing sections. Since the electrical capacity of the power-generating element housed in the particular housing section is the largest, the internal pressure of the particular housing section can be the lowest to direct the gas produced in the other housing sections toward the particular housing section. Once the gas is moved to the particular housing section, the gas can be released through the valve provided for the particular housing section.

The power-generating elements housed in the other housing sections can have the electrical capacities reduced gradually with the distance from the particular housing section in the predetermined direction. With such setting of the electrical capacities of the power-generating elements, the internal pressures of the housing sections can be reduced from the housing section farthest from the particular housing section toward the particular housing section, and the gas can be moved smoothly from the housing section farthest from the particular housing section toward the particular housing section.

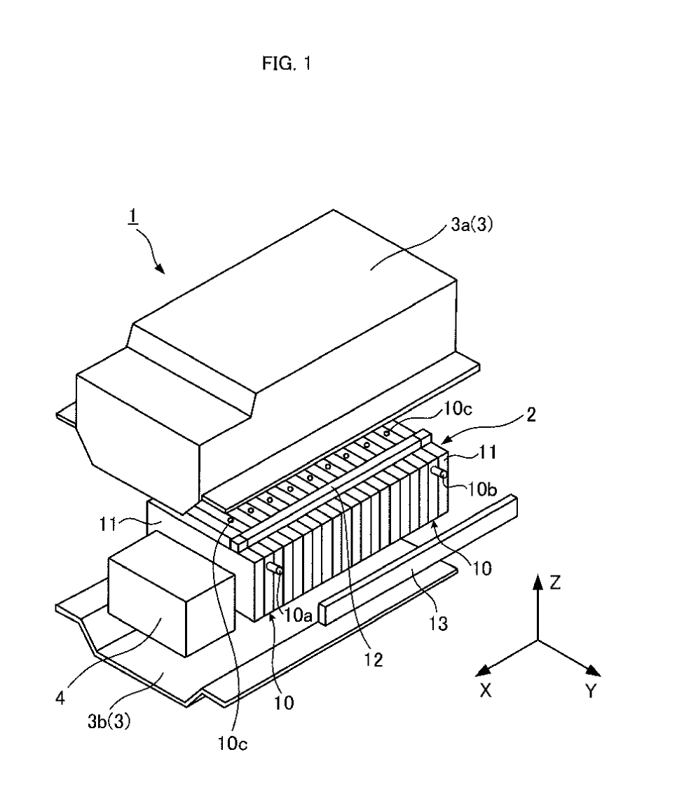

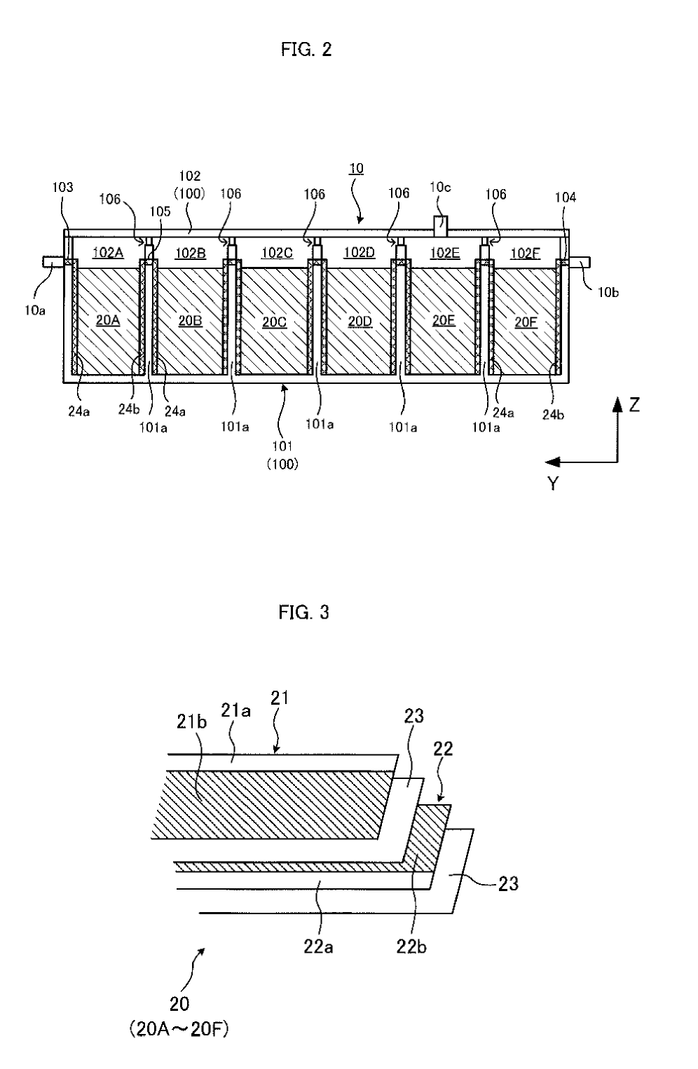

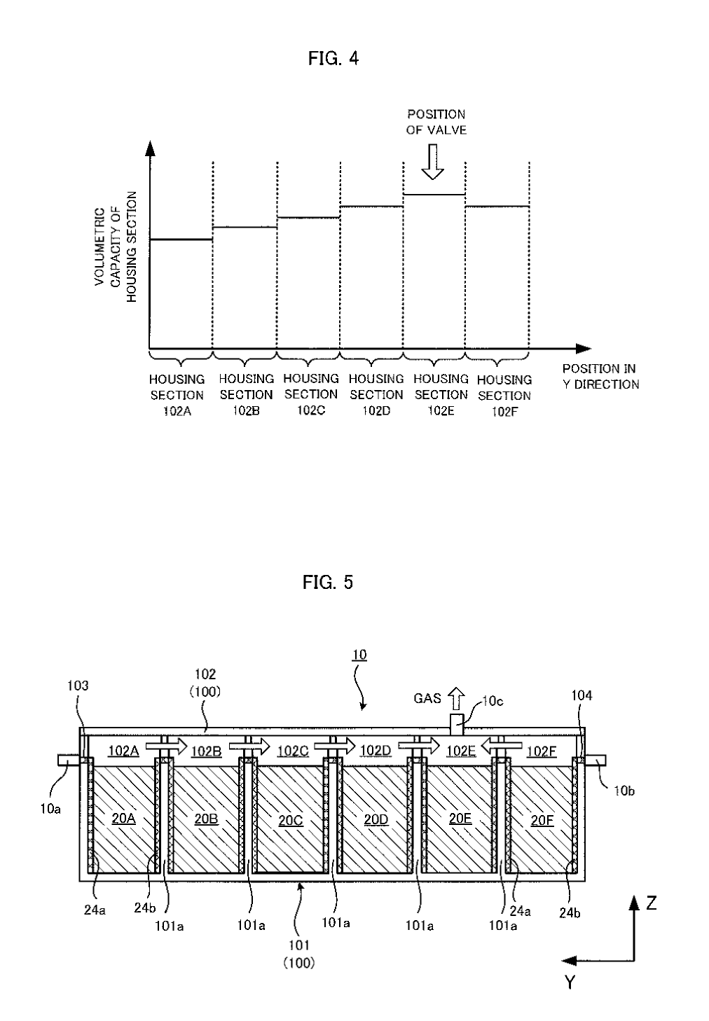

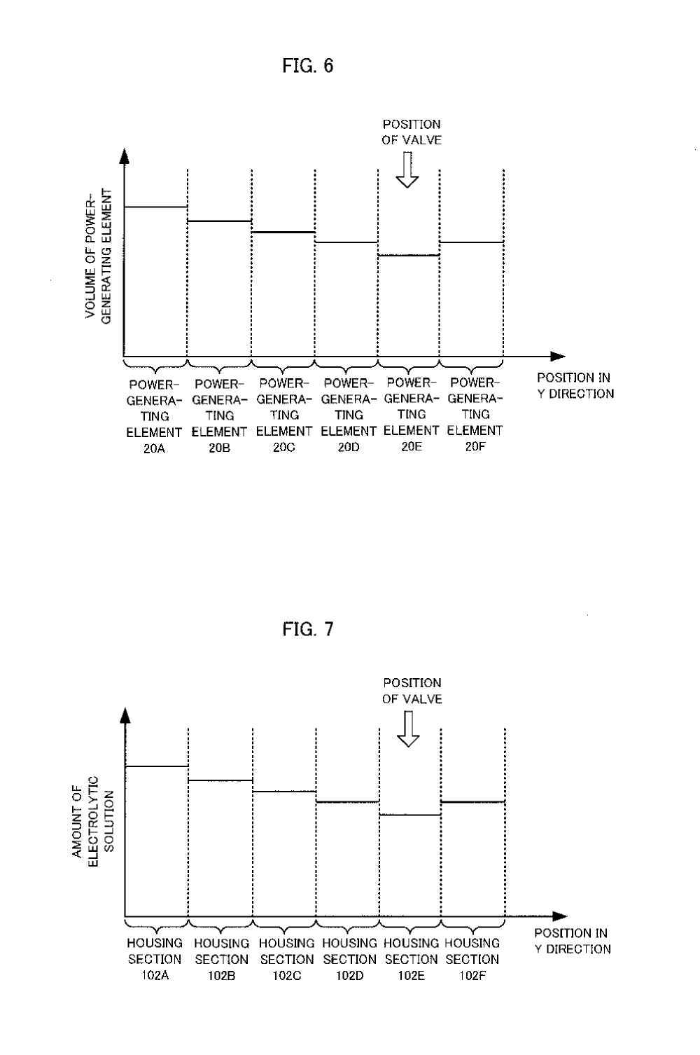

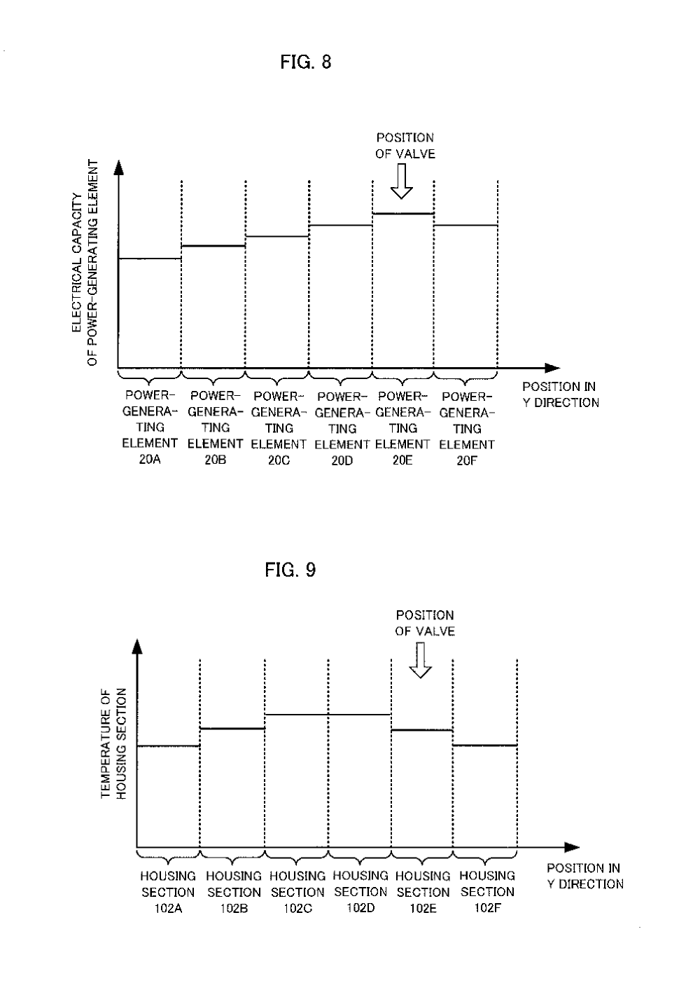

### BRIEF DESCRIPTION OF THE DRAWINGS

[FIG. 1] An exploded view of a battery pack in Embodiment 1.

[FIG. 2] A section view of a battery module in Embodiment 1.

[FIG. 3] A schematic diagram showing the configuration of a power-generating element in Embodiment 1.

[FIG. 4] A diagram showing the relationship between the positions of housing sections and the volumetric capacities of the housing sections in Embodiment 1.

[FIG. 5] A diagram for explaining the path of gas movement in the battery module of Embodiment 1.

[FIG. 6] A diagram showing the relationship between the positions of power-generating elements and the volumes of the power-generating elements in Embodiment 2.

[FIG. 7] A diagram showing the relationship between the positions of housing sections and the amounts of electrolytic solution filled into the housing sections in Embodiment 3.

[FIG. 8] A diagram showing the relationship between the positions of power-generating elements and the electrical capacities of the power-generating elements in Embodiment 4.

[FIG. 9] A diagram showing the relationship between the positions of housing sections and the temperatures of the housing sections.

### MODE FOR CARRYING OUT THE INVENTION

Embodiments of the present invention will hereinafter be described.

### Embodiment 1

Description is made of the configuration of a battery pack which is Embodiment 1 of the present invention with reference to FIG. 1. In FIG. 1, an X axis, a Y axis, and a Z axis are axes orthogonal to each other. In the present embodiment, the Z axis is defined as the axis corresponding to the vertical direction. The relationship among the X axis, the Y axis, and the Z axis applies to the other figures.

FIG. 1 is an exploded view of the battery pack 1. The battery pack 1 can be mounted on a vehicle, and examples of the vehicle include a hybrid vehicle and an electric vehicle. The hybrid vehicle uses not only the battery pack 1 but also another power source such as an internal-combustion engine and a fuel cell as the power source for running of the vehicle. The electric vehicle uses only the battery pack 1 as the power source for the vehicle.

The battery pack 1 has a battery stack 2 and a pack case 3 accommodating the battery stack 2. The pack case 3 has an upper case 3a and a lower case 3b connected to each other. The battery stack 2 has a plurality of battery modules (corresponding to an electrical storage device) 10 disposed along the X direction, and the plurality of battery modules 10 are connected electrically in series to each other.

A junction box 4 is disposed at a position adjacent to the battery stack 2 in the X direction. The pack case 3 also accommodates the junction box 4. The junction box 4 accommodates electronic devices for use in controlling charge and discharge of the battery stack 2. Examples of the electronic devices housed in the junction box 4 include a relay, a current sensor, and a monitor unit.

The relay is switched between ON and OFF to change the electrical connection between the battery stack 2 and a load. The current sensor is used to detect an electric current passing through the battery stack 2. The monitor unit monitors, for example, a current value, a voltage value, and a temperature in the battery stack 2. The monitor unit monitors the current value in the battery stack 2 based on the output from the current sensor. The monitor unit monitors a total voltage in the battery stack 2 and a voltage value in the battery module 10, for example. When a temperature sensor is attached on the battery stack 2, the monitor unit monitors the temperature of the battery stack 2 based on the output from the temperature sensor.

A pair of end plates 11 are disposed at both ends of the battery stack 2 in the X direction. A restraint band 12 extends in the X direction, and both ends of the restraint band 12 are connected to the pair of end plates 11. In the present embodiment, two restraint bands 12 are disposed on an upper face of the battery stack 2, and two restraint bands 12 are disposed on a lower face of the battery stack 2. The use of the end plates 11 and the restraint bands 12 can apply a restraint force to the plurality of battery modules 10. The restraint force is the force which presses and holds the battery module 10 in the X direction.

The battery module 10 has a positive electrode terminal 10a and a negative electrode terminal 10b. FIG. 1 shows only the positive electrode terminal 10a and the negative electrode terminal 10b of the battery module 10 disposed at both ends of the battery stack 2 in the X direction. The positive electrode terminal 10a and the negative electrode terminal 10b are provided on both sides of each of the battery modules 10 in the Y direction.

The two battery modules 10 adjacent to each other in the X direction are connected electrically in series through a bus bar. The bus bar is connected to the positive electrode terminal 10a of one of the two battery modules 10 and the negative electrode terminal 10b of the other battery module 10. A bus bar module 13 has a plurality of bus bars and a holder which holds the plurality of bus bars. The holder is made of an insulating material such as resin. The bus bar module 13 is disposed at each of the positions between which the battery stack 2 is sandwiched in the Y direction.

The battery module 10 has a plurality of ribs formed on a surface (X-Z plane) and protruding in the X direction. The two battery modules 10 adjacent to each other in the X direction are in contact with each other to form space between the two battery modules 10. The space serves as a path through which a heat exchange medium for use in adjusting the temperature of the battery module 10 moves. When the battery pack 1 is mounted on the vehicle, air in the vehicle interior, for example, can be used as the heat exchange medium. The vehicle interior refers to the space where passengers ride.

When the temperature of the battery module 10 rises, a heat exchange medium for cooing can be flowed through the space formed between the two battery modules 10 to suppress the temperature rise in the battery module 10. When the battery module 10 is excessively cooled, a heat exchange medium for heating can be flowed through the space formed between the two battery modules 10 to suppress the temperature drop in the battery module 10.

Next, the structure of the battery module 10 is described with reference to FIG. 2. FIG. 2 is a diagram showing the internal structure of the battery module 10 and is a section view of the battery module 10 when cut along a Y-Z plane.

The battery module 10 has a module case 100 which has a case body 101 and a lid 102. The lid 102 closes an opening portion formed at the top of the case body 101. The opening portion of the case body 101 is used for incorporating power-generating elements 20A to 20F into the case body 101. The case body 101 has six housing sections 102A to 102F which are separated by partitions 101a. The six housing sections 102A to 102F are disposed along the Y direction.

Although the six housing sections 102A to 102F are provided for the module case 100 in the present embodiment, the present invention is not limited thereto. The number of the housing sections can be set as appropriate.

The housing sections 102A to 102F accommodate the power-generating elements 20A to 20F, respectively. The power-generating elements 20A to 20F are the elements capable of charge and discharge and have the same configuration.

As shown in FIG. 3, the power-generating element 20 (20A to 20F) has a positive electrode plate 21, a negative electrode plate 22, and a separator (containing an electrolytic solution) 23 disposed between the positive electrode plate 21 and the negative electrode plate 22. The positive electrode plate 21 has a collector plate 21a and a positive electrode active material layer 21b formed on the surface of the collector plate 21a. The positive electrode active material layer 21b is formed on both surfaces of the collector plate 21a but is not formed in a region of the collector plate 21a. The positive electrode active material layer 21b includes a positive electrode active material, a conductive agent, a binder and the like.

The negative electrode plate 22 has a collector plate 22a and a negative electrode active material layer 22b formed on the surface of the collector plate 22a. The negative electrode active material layer 22b is formed on both surfaces of the collector plate 22a but is not formed in a region of the collector plate 22a. The negative electrode active material layer 22b includes a negative electrode active material, a conductive agent, a binder and the like.

The power-generating element 20 (20A to 20F) can be provided by using a known configuration which is used in a secondary battery such as a nickel metal hydride battery and a lithium-ion battery. Alternatively, the configuration of an electric double layer capacitor may be used instead of the secondary battery.

The housing sections 102A to 102F are filled with the electrolytic solution. The electrolytic solution filled into the housing sections 102A to 102F is infiltrated into the power-generating elements 20A to 20F and is also present in the space other than the power-generating elements 20A to 20F within the housing sections 102A to 102F. The electrolytic solution is infiltrated into the separator 23 and the active material layers 21b and 22b. In the present embodiment, the housing sections 102A to 102F are filled with the same amount of the electrolytic solution.

Although the electrolytic solution is used in the present embodiment, a solid electrolyte may be used. In other words, the solid electrolyte may be used instead of the separator 23 containing the electrolytic solution. Examples of the solid electrolyte include an inorganic solid electrolyte and an organic solid electrolyte.

A positive electrode tab 24a and a negative electrode tab 24b are connected to each of the power-generating elements 20A to 20F. The positive electrode tab 24a is connected to the positive electrode plate 21 of each of the power-generating elements 20A to 20F, and the negative electrode tab 24b is connected to the negative electrode plate 22 of each of the power-generating elements 20A to 20F. The positive electrode tab 24a for the power-generating element 20A passes through a connecting hole 103 formed in the module case 100 (case body 101) and is connected to the positive electrode terminal 10a. The negative electrode tab 24b for the power-generating element 20A passes through a connecting hole 105 formed in the module case 100 (partition 101a) and is connected to the positive electrode tab 24a for the power-generating element 20B.

Each of the power-generating elements 20B to 20E is connected electrically to the power-generating element adjacent thereto in the Y direction. The positive electrode tab 24a for the power-generating element 20F passes through the connecting hole 105 formed in the partition 101a and is connected to the negative electrode tab 24b for the power-generating element 20E. The negative electrode tab 24b for the power-generating element 20F passes through a connecting hole 104 formed in the case body 101 and is connected to the negative electrode terminal 10b.

A communication path 106 is formed above the partition 101a. The communication path 106 is provided to connect the adjacent two of the housing sections 102A to 102F in the Y direction. While the internal pressure of each of the housing sections 102A to 102F is not increased, the communication path 106 is in a closed state.

The closed state of the communication path 106 can suppress a change in electrical capacity of each of the power-generating elements 20A to 20F housed in the respective housing sections 102A to 102F. The electrical capacity of each of the power-generating elements 20A to 20F may depend on gas present within the respective housing sections 102A to 102F, that is, the internal pressure of the respective housing sections 102A to 102F.

If the communication path 106 remains an opened state, gas within a particular one of the housing sections moves to the other housing section adjacent thereto in the Y direction. The movement of the gas changes the electrical capacity of the power-generating element housed in the particular housing section, thereby presenting a difficulty in controlling the charge and discharge of the battery module 10 based on the electrical capacity of the power-generating element. In the present embodiment, to suppress the movement of the gas between adjacent two of the housing sections 102A to 102F in the Y direction, the communication path 106 is set to the closed state under predetermined conditions. In addition, the closed state of the communication path 106 can prevent the electrolytic solution filled in each of the housing sections 102A to 102F from moving to the other housing sections.

The communication path 106 switches from the closed state to the opened state when the internal pressure difference between the adjacent two of the housing sections 102A to 102F in the Y direction reaches a threshold value. For example, when gas is produced from the power-generating element 20A to cause the internal pressure of the housing section 102A to be higher than the internal pressure of the housing section 102B, the communication path 106 switches from the closed state to the opened state. The gas present within the housing section 102A moves through the communication path 106 to the housing section 102B.

The communication path 106 allows only the unidirectional movement of the gas. Specifically, the communication path 106 allows only the movement of the gas from the housing section 102A toward the housing section 102B. The communication path 106 can be formed of a check valve, for example.

A valve 10c is provided for the housing section 102E. When the internal pressure of the module case 100 reaches the operating pressure of the valve 10c, the valve 10c switches from a closed state to an opened state. This causes the valve 10c to release the gas produced within the module case 100 to the outside of the module case 100.

A so-called break type valve or a so-called recovery type valve can be used as the valve 10c. The break type valve 10c irreversibly switches from a closed state to an opened state. The recovery type valve reversibly switches between a closed state and an opened state. The recovery type valve switches between the closed state and the opened state depending on the internal and external pressures of the module case 100.

The gas produced in the housing section 102E moves toward the valve 10c and is then released to the outside of the module case 100 through the valve 10c. The gas produced in any of the housing sections 102A to 102D and 102F passes through the communication path 106 toward the housing section 102E and is then released to the outside of the module case 100 through the valve 10c.

In the present embodiment, the power-generating elements 20A to 20F have the same size and the same configuration. On the other hand, the housing sections 102A to 102F have different volumetric capacities as described below. FIG. 4 is a diagram showing the relationship between the volumetric capacities of the housing sections 102A to 102F and the positions of the housing sections 102A to 102F.

The housing section 102E has the largest volumetric capacity. The volumetric capacity of the housing section 102F is smaller than the volumetric capacity of the housing section 102E. The volumetric capacity of the housing section 102D is smaller than the volumetric capacity of the housing section 102E. The volumetric capacities of the housing sections 102F and 102D may be the same or different. The volumetric capacity of the housing section 102C is smaller than the volumetric capacity of the housing section 102D, and the volumetric capacity of the housing section 102B is smaller than the volumetric capacity of the housing section 102C. The volumetric capacity of the housing section 102A is smaller than the volumetric capacity of the housing section 102B.

Although the housing section 102A has the smallest volumetric capacity in the present embodiment, the present invention is not limited thereto. For example, the housing sections 102A and 102F have an equal volumetric capacity, or the housing section 102F may have the smallest volumetric capacity.

To vary the capacity among the housing sections 102A to 102F, for example, the thickness of the case body 101 (including the partition 101a) can be varied depending on the positions of the housing sections 102A to 102F. For example, the portion of the case body 101 forming the housing section 102A can have the largest thickness, and the portion of the case body 101 forming the housing section 102E can have the smallest thickness.

Alternatively, the case body 101 having the housing sections 102A to 102F of an equal volumetric capacity can be manufactured, and then a filling member can be put in each of the housing sections 102A to 102F to partially fill the space in the housing sections 102A to 102F. The filling member can be placed along the inner wall face of each of the housing sections 102A to 102F. In this case, the filling member preferably has a shape conforming to the inner wall face of each of the housing sections 102A to 102F.

The filling member, when used, may not be put in the housing section 102E and may be placed only in the other housing sections 102A to 102D and 102F, for example. The thickness of the filling member may be varied among the housing sections 102A to 102D and 102F.

In the present embodiment, as shown in FIG. 4, the housing section 102E provided with the valve 10c has the largest volumetric capacity, and the housing sections 102A to 102D and 102F have the volumetric capacities reduced stepwise with the distance from the housing section 102E in the Y direction. Such setting of the volumetric capacities of the housing sections 102A to 102F can produce the flows of gas indicated by arrows in the housing sections 102A to 102F as shown in FIG. 5.

When gas is produced from the power-generating elements 20A to 20F due to overcharge of the battery module 10 or the like, the gas stays in each of the housing sections 102A to 102F to increase the internal pressure of each of the housing sections 102A to 102F. Since each of the housing sections 102A to 102F is in a sealed state, the gas produced from the power-generating elements 20A to 20F stays in the space other than the power-generating elements 20A to 20F in each of the housing sections 102A to 102F. If the gas continues to be produced, the internal pressure of each of the housing sections 102A to 102F is increased.

Since the housing section 102A has the smallest volumetric capacity in the present embodiment, the internal pressure of the housing section 102A is increased most easily if an equal amount of gas is produced from the power-generating element 20A to 20F. When the internal pressure of the housing section 102A reaches the threshold value, the communication path 106 disposed between the housing section 102A and the housing section 102B switches from the closed state to the opened state to move the gas within the housing section 102A to the housing section 102B. This allows the gas to stay in the housing sections 102A and 102B to equalize the internal pressures of the housing sections 102A and 102B.

When the internal pressures of the housing sections 102A and 102B reach the threshold value, the communication path 106 disposed between the housing section 102B and the housing section 102C switches from the closed state to the opened state. Since the volumetric capacity of the housing section 102B is smaller than the volumetric capacity of the housing section 102C, the internal pressures of the housing sections 102A and 102B easily become higher than the internal pressure of the housing section 102C. The gas within the housing sections 102A and 102B passes through the communication path 106 in the opened state and moves to the housing section 102C. This allows the gas to stay in the housing sections 102A to 102C to equalize the internal pressures of the housing sections 102A to 102C.

When the internal pressures of the housing sections 102A to 102C reach the threshold value, the communication path 106 disposed between the housing section 102C and the housing section 102D switches from the closed state to the opened state. Since the volumetric capacity of the housing section 102C is smaller than the volumetric capacity of the housing section 102D, the internal pressures of the housing sections 102A to 102C easily become higher than the internal pressure of the housing section 102D. The gas within the housing sections 102A to 102C passes through the communication path 106 in the opened state and moves to the housing section 102D. This allows the gas to stay in the housing sections 102A to 102D to equalize the internal pressures of the housing sections 102A to 102D.

When the internal pressures of the housing sections 102A to 102D reach the threshold value, the communication path 106 disposed between the housing section 102D and the housing section 102E switches from the closed state to the opened state. Since the volumetric capacity of the housing section 102D is smaller than the volumetric capacity of the housing section 102E, the internal pressures of the housing sections 102A to 102D easily become higher than the internal pressure of the housing section 102E. The gas within the housing sections 102A to 102D passes through the communication path 106 in the opened state and moves to the housing section 102E. This allows the gas to stay in the housing sections 102A to 102E to equalize the internal pressures of the housing sections 102A to 102E.

When the internal pressure of the housing section 102F reaches the threshold value, the communication path 106 disposed between the housing section 102F and the housing section 102E switches from the closed state to the opened state. Since the volumetric capacity of the housing section 102F is smaller than the volumetric capacity of the housing section 102E, the internal pressure of the housing section 102F easily becomes higher than the internal pressure of the housing section 102E. The gas within the housing section 102F passes through the communication path 106 in the opened state and moves to the housing section 102E. This allows the gas to stay in the housing sections 102E and 102F to equalize the internal pressures of the housing sections 102E and 102F.

When the internal pressure of the module case 100 (housing sections 102A to 102F) reaches the operating pressure of the valve 10c, the valve 10c switches from the closed state to the opened state. The switching of the valve 10c from the closed state to the opened state can release the gas produced within the module case 100 to the outside of the module case 100.

According to the present embodiment, the volumetric capacity can be varied among the housing sections 102A to 102F to reduce the internal pressures of the housing sections 102A to 102F from the housing section 102A to the housing section 102E and from the housing section 102F to the housing section 102E. Thus, the gas can be moved smoothly from the housing section 102A to the housing section 102E or from the housing section 102F to the housing section 102E. In addition, the internal pressures of the two adjacent housing sections in the Y direction can be equalized while the gas is moved from the housing section 102A toward the housing section 102E.

If the housing sections 102A to 102F have an equal volumetric capacity, the internal pressure of the housing section 102B may be higher than the internal pressure of the housing section 102A, for example. In this case, gas produced in the housing section 102A moves less smoothly to the housing section 102B. If the gas produced in the housing section 102A moves less smoothly to the housing section 102B over a certain time period, the internal pressure of the housing section 102A continues to be increased to apply an excessive load to the housing section 102A (module case 100).

In the present embodiment, the gas can be moved smoothly from the housing section 102A toward the housing section 102E, and the gas can be moved smoothly from the housing section 102F toward the housing section 102E. This can prevent the excessive increase of the internal pressure of the particular housing section which is occurred by preventing the gas produced in a particular one of the housing sections (one of the housing sections 102A to 102D and 102F) from moving to the housing section 102E. In addition, during the movement of the gas from the housing section 102A toward the housing section 102E, the internal pressures of the plurality of housing sections connected to each other through the communication path 106 can be equalized. Thus, when the internal pressure of the module case 100 including all the housing sections 102A to 102F reaches the operating pressure of the valve 10c, the valve 10c can be switched from the closed state to the opened state.

Although the housing section 102E has the largest volumetric capacity, and the housing sections 102A to 102D and 102F have the volumetric capacities reduced stepwise with the distance from the housing section 102E in the Y direction in the present embodiment, the present invention is not limited thereto. Specifically, it is only required that the volumetric capacity of the housing section 102E should be larger than the volumetric capacities of the other housing sections 102A to 102D and 102F. For example, the housing section 102E may have the largest volumetric capacity, and the other housing sections 102A to 102D and 102F may have an equal volumetric capacity. In this case, gas produced in any of the housing sections 102A to 102D and 102F can also be directed toward the housing section 102E and released to the outside of the module case 100 through the valve 10c.

In the present embodiment, the difference in the volumetric capacity between the adjacent two of the housing sections 102A to 102F in the Y direction can be set as appropriate in view of the internal pressure set in each of the housing sections 102A to 102F. Specifically, the differences in the volumetric capacity between the adjacent twos of the housing sections 102A to 102F in the Y direction can be the same or different.

### Embodiment 2

Description is made of a battery module 10 which is Embodiment 2 of the present invention. In the present embodiment, the members identical to those of the members described in Embodiment 1 are designated with the same reference numerals, and detailed description thereof is omitted. In the present embodiment, description is made mainly of differences from Embodiment 1.

The volumetric capacity is varied among the housing sections 102A to 102F in Embodiment 1. In the present embodiment, however, housing sections 102A to 102F have an equal volumetric capacity, and power-generating elements 20A to 20F have different volumes. The housing sections 102A to 102F have the equal volumetric capacity and the power-generating elements 20A to 20F have an equal electrical capacity in the present embodiment.

FIG. 6 is a diagram showing the relationship between the volumes of the power-generating elements 20A to 20F and the positions of the power-generating elements 20A to 20F. The power-generating element 20E has the smallest volume. The power-generating elements 20F and 20D have volumes larger than the volume of the power-generating element 20E. The volumes of the power-generating elements 20F and 20D may be the same or different.

The volume of the power-generating element 20C is larger than the volume of the power-generating element 20D, and the volume of the power-generating element 20B is larger than the volume of the power-generating element 20C. The power-generating element 20A has the largest volume. Although the power-generating element 20A has the largest volume in the present embodiment, the present invention is not limited thereto. For example, the power-generating elements 20A and 20F may have an equal volume, or the power-generating element 20F may have the largest volume.

When the housing sections 102A to 102F have an equal volume, the empty spaces other than the power-generating elements 20A to 20F in the housing sections 102A to 102F depend on the volumes of the power-generating elements 20A to 20F. The empty space is reduced as the volume of the power-generating elements 20A to 20F is increased. When gas is produced from the power-generating elements 20A to 20F, the internal pressure of the housing sections 102A to 102F is easily increased as the empty space is reduced.

Each of the power-generating elements 20A to 20F has a reaction area contributing to charge and discharge and a non-reaction area other than the reaction area. To provide the different volumes for the power-generating elements 20A to 20F, the non-reaction areas can be formed to have different volumes. This can vary the volumes among the power-generating elements 20A to 20F without varying the electrical capacity among the power-generating elements 20A to 20F.

For example, the size of a separator 23 can be varied, or a filling member only for increasing the volume of each of the power-generating elements 20A to 20F can be added to an outer face of each of the power-generating elements 20A to 20F. The size of the separator 23 refers to the size of the non-reaction area and includes the length in a direction orthogonal to the stacking direction of the positive electrode plate 21 and the negative electrode plate 22. The filling member is only required to fill the empty space, and can be formed by using a plate made of polypropylene, for example. The shape of the filling member may be set as appropriate based on the shapes of the housing sections 102A to 102F and the power-generating elements 20A to 20F.

According to the present embodiment, similarly to Embodiment 1, the housing section 102A can have the highest internal pressure, and the internal pressures of the housing section 102A to 102E can be reduced stepwise from the housing section 102A toward the housing section 102E. This allows the smooth movement of gas from the housing section 102A toward the housing section 102E. Since the internal pressure of the housing section 102F can be higher than the internal pressure of the housing section 102E, the gas can be moved easily from the housing section 102F toward the housing section 102E. Thus, the gas produced in the housing sections 102A to 102D and 102F can be directed to the housing section 102E and be released through the valve 10c. This can prevent an excessive increase of internal pressure in only some of the housing sections.

Although the power-generating element 20E has the smallest volume and the power-generating elements 20A to 20D and 20F have the volumes increased stepwise with the distance from the power-generating element 20E in the Y direction in the present embodiment, the present invention is not limited thereto. Specifically, it is only required that the volume of the power-generating element 20E should be smaller than the volumes of the power-generating elements 20A to 20D and 20F. For example, the power-generating element 20E may have the smallest volume, and the other power-generating elements 20A to 20D and 20F may have an equal volume. In this case, the gas produced in the housing sections 102A to 102D and 102F can be directed to the housing section 102E and be released to the outside of the module case 100 through the valve 10c.

In the present embodiment, the differences in the volume between the adjacent twos of the power-generating elements 20A to 20F in the Y direction can be the same or different. The difference in the volume can be set as appropriate in view of the internal pressure set in each of the housing sections 102A to 102F.

### Embodiment 3

Description is made of a battery module 10 which is Embodiment 3 of the present invention. In the present embodiment, the members identical to those of the members described in Embodiment 1 are designated with the same reference numerals, and detailed description thereof is omitted. In the present embodiment, description is made mainly of differences from Embodiment 2.

Although the volume is varied among the power-generating elements 20A to 20F in Embodiment 2, the amount of electrolytic solution filled into the housing sections 102A to 102F is varied in the present embodiment. The amount of electrolytic solution in this case refers to the amount (volume) of electrolytic solution present in the empty spaces of the housing sections 102A to 102F.

In the present embodiment, the housing sections 102A to 102F have an equal volumetric capacity, and power-generating elements 20A to 20F have an equal volume.

FIG. 7 is a diagram showing the relationship between the amounts (volumes) of electrolytic solution present in the empty spaces and the positions of the housing sections 102A to 102F. The housing section 102E contains the smallest amount of electrolytic solution. The amounts of electrolytic solution in the housing sections 102D and 102F are larger than the amount of electrolytic solution in the housing section 102E. The amounts of electrolytic solution in the housing sections 102D and 102F may be the same or different.

The amount of electrolytic solution in the housing section 102C is larger than the amount of electrolytic solution in the housing section 102D, and the amount of electrolytic solution in the housing section 102B is larger than the amount of electrolytic solution in the housing section 102C. The amount of electrolytic solution in the housing section 102A is larger than the amount of electrolytic solution in the housing section 102B. Although the housing section 102A contains the largest amount of electrolytic solution in the present embodiment, the present invention is not limited thereto. Specifically, the housing sections 102A and 102F can contain an equal amount of electrolytic solution, or the housing section 102F can contain the largest amount of electrolytic solution.

In the present embodiment, the housing section 102E contains the largest amount of electrolytic solution, and the housing sections 102A to 102D and 102F contain the amounts of electrolytic solution increased stepwise with the distance from the housing section 102E in the Y direction. Since the empty space is reduced as the amount of electrolytic solution is increased, the internal pressure of the housing sections 102A to 102F is easily increased when gas is produced from the power-generating elements 20A to 20F.

With the setting of the amounts of electrolytic solution as in the present embodiment, similarly to Embodiment 1, the housing section 102A can have the highest internal pressure and the internal pressures of the housing sections 102A to 102E can be reduced stepwise from the housing section 102A toward the housing section 102E. This allows the smooth movement of gas from the housing section 102A toward the housing section 102E. Since the internal pressure of the housing section 102F can be higher than the internal pressure of the housing section 102E, the gas can be moved easily from the housing section 102F toward the housing section 102E. Thus, the gas produced in the housing sections 102A to 102D and 102F can be directed to the housing section 102E and be released through the valve 10c. This can prevent an excessive increase of internal pressure in only some of the housing sections.

Although the housing section 102E contains the smallest amount of electrolytic solution and the amounts of electrolytic solution are increased stepwise with the distance from the housing section 102E in the Y direction in the present embodiment, the present invention is not limited thereto. Specifically, it is only required that the amount of electrolytic solution in the housing section 102E should be smaller than the amounts of electrolytic solution in the housing sections 102A to 102D and 102F. For example, the housing section 102E may contain the smallest amount of electrolytic solution, and the other housing sections 102A to 102D and 102F may contain an equal amount of electrolytic solution. In this case, the gas produced in the housing sections 102A to 102D and 102F can also be directed to the housing section 102E and be released to the outside of a module case 100 through the valve 10c.

In the present embodiment, the differences in the amount of electrolytic solution between the adjacent twos of the housing sections 102A to 102F in the Y direction can be the same or different. The difference in the amount of electrolytic solution can be set as appropriate in view of the internal pressure set in each of the housing sections 102A to 102F.

In Embodiments 1 to 3 described above, the variations are created in one of the volumetric capacities of the housing sections 102A to 102F (referred to as a first parameter), the volumes of the power-generating elements 20A to 20F (referred to as a second parameter), and the amounts of electrolytic solution in the housing sections 102A to 102F (referred to as a third parameter). However, the present invention is not limited thereto.

Thus, the variations can be created in at least two of the first parameter to the third parameter. As described in Embodiments 1 to 3, it is only required that the empty space in the housing section 102E provided with the valve 10c should be larger than the empty spaces in the housing sections 102A to 102D and 102F. More preferably, the empty spaces may be increased in stepwise with the distance from the housing section 102E in the Y direction.

### Embodiment 4

Description is made of a battery module 10 which is Embodiment 4 of the present invention. In the present embodiment, the members identical to those of the members described in Embodiment 1 are designated with the same reference numerals, and detailed description thereof is omitted. In the present embodiment, description is made mainly of differences from Embodiment 2.

In Embodiment 2, the volume is varied among the power-generating elements 20A to 20F without varying the size of the reaction area among the power-generating elements 20A to 20F, that is, without varying the electrical capacity among the power-generating elements 20A to 20F. In the present embodiment, the electrical capacity is varied among power-generating elements 20A to 20F without varying the volume among the power-generating elements 20A to 20F. Only the electrical capacity can be varied among the power-generating elements 20A to 20F by varying the size of reaction area among the power-generating elements 20A to 20F without varying the volume among the power-generating elements 20A to 20F.

In the present embodiment, housing sections 102A to 102F have an equal volumetric capacity and the housing sections 102A to 102F are filled with an equal amount of electrolytic solution.

FIG. 8 shows the relationship between the electrical capacities of the power-generating elements 20A to 20F and the positions of the power-generating elements 20A to 20F. The power-generating element 20E has the largest electrical capacity, and the power-generating elements 20D and 20F have electrical capacities smaller than the electrical capacity of the power-generating element 20E. The electrical capacities of the power-generating elements 20D and 20F may be the same or different.

The electrical capacity of the power-generating element 20C is smaller than the electrical capacity of the power-generating element 20D, and the electrical capacity of the power-generating element 20B is smaller than the electrical capacity of the power-generating element 20C. The electrical capacity of the power-generating element 20A is smaller than the electrical capacity of the power-generating element 20B. Although the power-generating element 20A has the smallest electrical capacity in the present embodiment, the present invention is not limited thereto. Specifically, the power-generating element 20F may have the smallest electrical capacity, or the power-generating elements 20A and 20F may have an equal electrical capacity.

If the electrical capacity is varied too greatly among the power-generating elements 20A to 20F, the power-generating element 20A having the smallest electrical capacity is relied on to perform the charge and discharge of the battery module 10 to hinder the effective utilization of the other power-generating elements 20B to 20F. This problem can be addressed, for example, by presetting the range in which electrical capacity variations among the power-generating elements 20A to 20F can be allowed and varying the electrical capacity among the power-generating elements 20A to 20F within the allowable range. This enables all the power-generating elements 20A to 20F to be efficiently utilized in the charge and discharge of the battery module 10.

In the present embodiment, the power-generating element 20E has the largest electrical capacity, and the power-generating elements 20A to 20D and 20F have the electrical capacities reduced stepwise with the distance from the power-generating element 20E in the Y direction. As the electrical capacity of the power-generating elements 20A to 20F is increased, the amount of gas produced from the power-generating elements 20A to 20F can be reduced. Thus, the internal pressure of the housing section 102E can be lower than the internal pressures of the other housing sections 102A to 102D and 102F. The internal pressures of the housing sections 102A to 102E can be reduced stepwise from the housing section 102A toward the housing section 102E.

According to the present embodiment, the gas can be moved smoothly from the housing section 102A toward the housing section 102E, or the gas can be moved smoothly from the housing section 102F toward the housing section 102E, similarly to Embodiment 1. This allows the gas produced in all the housing sections 102A to 102F to be released to the outside of the module case 100 through the valve 10c, thereby preventing an excessive increase of internal pressure in only some of the housing sections.

In the present embodiment, the differences in the electrical capacity between the adjacent twos of the power-generating elements 20A to 20F in the Y direction can be the same or different. The difference in the electrical capacity can be set as appropriate in view of the internal pressure set in each of the housing sections 102A to 102F.

Although only the positions of the housing sections 102A to 102F are considered in Embodiments 1 to 4 described above, the present invention is not limited thereto. Specifically, a temperature distribution in the housing sections 102A to 102F can be considered in addition to the positions of the housing sections 102A to 102F.

As described in FIG. 1, the battery modules 10 are placed along the X direction. When the plurality of battery modules 10 are placed along the X direction, the central portion of each of the battery modules 10 in the Y direction dissipates less heat and tends to hold heat therein. Each end portion of the battery module 10 in the Y direction easily dissipates heat and does not tend to hold heat therein. As a result, the battery module 10 may have the temperature distribution shown in FIG. 9.

In the housing section in which the temperature easily rises, gas may be produced easily and the internal pressure of that housing section may tend to be increased. Thus, the temperature distribution shown in FIG. 9 can be taken into account to adjust the internal pressure set in each of the housing sections 102A to 102F. Specifically, the differences in internal pressure between adjacent twos of the housing sections 102A to 102F in the Y direction can be set in view of the temperature distribution shown in FIG. 9.

For example, the difference in internal pressure between the two housing sections 102B and 102C disposed closer to the central portion of the battery module 10 in the Y direction can be larger than the difference in internal pressure between the two housing sections 102A and 102B disposed closer to the end portion of the battery module 10 in the Y direction. Once the differences in internal pressure are determined in this manner, the resulting internal pressure of each of the housing sections 102A to 102F can be taken into account to determine the volumetric capacities of the housing sections 102A to 102F, the volumes of the power-generating elements 20A to 20F, the amounts of electrolytic solution, and the electrical capacities of the power-generating elements 20A to 20F. Referring to the configuration described in Embodiment 1 (FIG. 4) for description, the difference in volumetric capacity between the housing sections 102B and 102C can be larger than the difference in volumetric capacity between the housing sections 102A and 102B.

Although the valve 10c is provided for the housing section 102E in the battery module 10 in Embodiments 1 to 4, the present invention is not limited thereto. Specifically, based on the housing section provided with the valve 10c, the volumetric capacities of the housing sections 102A to 102F, the volumes of the power-generating elements 20A to 20F, the amounts of electrolytic solution, and the electrical capacities of the power-generating elements 20A to 20F can be determined. For example, when the volumetric capacity is varied among the housing sections 102A to 102F, the housing section provided with the valve 10c may have the largest volumetric capacity, and the other housing sections may have volumetric capacities reduced stepwise with the distance from the housing section provided with the valve 10c in the Y direction.

1. An electrical storage device comprising:
a plurality of power-generating elements connected electrically in series to each other and performing charge and discharge;
a case including a plurality of housing sections and a communication path, each of the housing sections accommodating one of the plurality of power-generating elements, the housing sections disposed along a predetermined direction, the communication path switching from a closed state to an opened state depending on an internal pressure of the housing section and allowing movement of gas between two of the housing sections adjacent to each other in the predetermined direction in the opened state; and
a valve provided for a particular one of the housing sections and releasing gas produced within the case to the outside of the case,
wherein an empty space other than the power-generating element is present in each of the housing sections, and the empty space in the particular housing section is the largest.

2. The electrical storage device according to claim 1, wherein the housing sections other than the particular housing section one have the empty spaces reduced gradually with a distance from the particular housing section in the predetermined direction.

3. The electrical storage device according to claim 1, wherein the plurality of power-generating elements have the same volume, and
the particular housing section has a volumetric capacity larger than volumetric capacities of the other housing sections.

4. The electrical storage device according to claim 1, wherein the plurality of housing sections have the same volumetric capacity and the plurality of power-generating elements have the same electrical capacity, and
the power-generating element housed in the particular housing section has a volume smaller than volumes of the power-generating elements housed in the other housing sections.

5. The electrical storage device according to claim 4, wherein the power-generating element has a reaction area where charge and discharge occur and a non-reaction area other than the reaction area, and
the non-reaction area of the power-generating element housed in the particular housing section is smaller than the non-reaction areas of the power-generating elements housed in the other housing sections.

6. The electrical storage device according to claim 1, further comprising an electrolytic solution filled into each of the housing sections,
wherein the plurality of housing sections have the same volumetric capacity and the plurality of power-generating elements have the same volume, and
an amount of the electrolytic solution filled into the particular housing section is smaller than amounts of the electrolytic solution filled into the other housing sections.

7. An electrical storage device comprising:
a plurality of power-generating elements connected electrically in series to each other and performing charge and discharge;
a case including a plurality of housing sections and a communication path, each of the housing sections accommodating one of the plurality of power-generating elements, the housing sections disposed along a predetermined direction, the communication path switching from a closed state to an opened state depending on an internal pressure of the housing section and allowing movement of gas between two of the housing sections adjacent to each other in the predetermined direction in the opened state; and
a valve provided for a particular one of the housing sections and releasing gas produced within the case to the outside of the case,
wherein a full charge capacity of the power-generating element housed in the particular the housing section is the largest.

8. The electrical storage device according to claim 7, wherein the housing sections other than the particular housing section accommodate the power-generating elements having full charge capacities reduced gradually with a distance from the particular housing section in the predetermined direction.
